(19) United States
(12) Patent Application Publication
(10) Pub. No.: US 2005/0209858 A1
(43) Pub. Date: Sep. 22, 2005

(54) Apparatus and method for voice activated communication

(76) Inventor: Robert Zak, Apex, NC (US)

Correspondence Address: COATS & BENNETT/SONY ERICSSON, 1400 CRESCENT GREEN, SUITE 300, CARY, NC, 27511, US

(21) Appl. No.: 10/801,779

(22) Filed: Mar. 16, 2004

(51) Int. Cl. H04M 1/64

(52) U.S. Cl. 704/275

(57) ABSTRACT

A wireless communication device includes a transceiver to communicate in a push-to-talk mode, and a speech processor having a voice recognition engine. The speech processor detects and processes speech signals input by a user and recognizes predetermined voice commands uttered by the user. The transceiver may be controlled to transmit the speech signals in the push-to-talk mode responsive to the detection of the predetermined voice commands.

### BACKGROUND

The present invention relates generally to wireless communications devices, and particularly to voice activated wireless communications devices.

Wireless communications devices in some cellular networks may soon enjoy support for a push-to-talk (PTT) protocol for packet data. The PTT service, which is most often associated with private radio systems, allows point-to-multipoint communications and provides faster access with respect to call setup. Further, because packet data transmissions use less bandwidth than do voice transmissions, transmitting voice via a packet data network (e.g., GSM) helps to decrease costs. However, PTT transmissions necessarily require a user to press and hold a button on the wireless communications device while speaking into a microphone. This makes it difficult, and in some states illegal, for users to communicate with remote parties while engaged in activities such as driving an automobile. Accordingly, what is needed is a way to permit users of cellular devices to take advantage of a PTT service without having to submit to some of the conventional limitations.

### SUMMARY

In one embodiment, a wireless communication device according to the present invention operates in a packet data communications system having one or more base stations. The wireless communications device comprises a transceiver to communicate in a push-to-talk mode, and a speech processor. The speech processor includes a voice recognition engine to process speech signals input by the user, and to recognize predetermined voice commands. The transceiver transmits the speech signals in the push-to-talk mode responsive to predetermined keywords or voice commands issued by the user. In one embodiment, a first keyword or command uttered by the user keys the transmitter and begins transmitting the speech signals. A second keyword or command uttered by the user unkeys the transmitter and stops transmitting the speech signals. Other keywords or commands are also possible.

In an alternate embodiment, a controller operatively connected to the transceiver and the speech processor controls the transceiver to transmit a prerecorded message intended for one or more recipients. As above, one predetermined voice command permits the user to record the message, while other predetermined voice commands allow the user to select recipient(s), transmit the message, and stop transmitting the message.

### BRIEF DESCRIPTION OF THE DRAWINGS

FIG. 1 illustrates a wireless communications network according to one embodiment of the present invention.

FIG. 2 illustrates a wireless communications device according to one embodiment of the present invention.

FIGS. 3A and 3B illustrate a menu system that may be used with a wireless communications device operating according to one embodiment of the present invention.

FIGS. 4A and 4B illustrate a method according to one embodiment of the present invention.

FIG. 5 illustrates an alternate method according to one embodiment of the present invention.

FIG. 6 illustrates some of the possible functions that may be controlled using the present invention.

### DETAILED DESCRIPTION

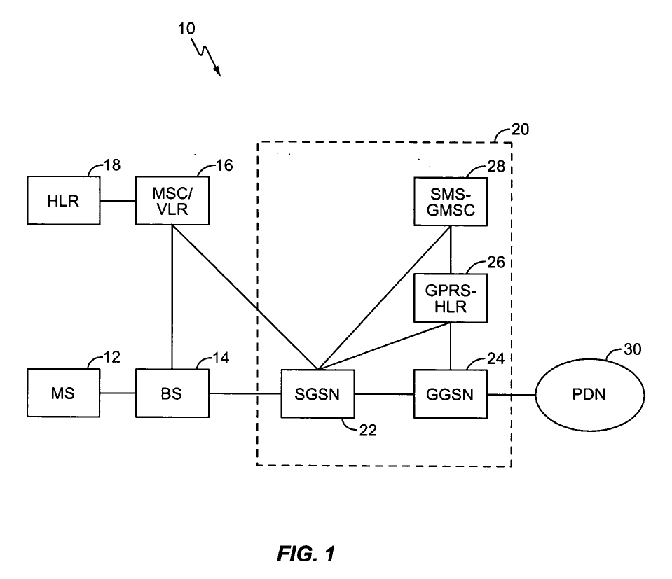

Referring now to the drawings, FIG. 1 shows the logical architecture of a communications network that may be used in the present invention. In FIG. 1, mobile communication network 10 interfaces with a packet-switched network 20. For illustrative purposes, the packet-switched network 20 implements the General Packet Radio Service (GPRS) standard developed for Global System for Mobile Communications (GSM) networks, though other standards may be employed. Additionally, networks other than packet-switched networks may also be employed.

The mobile communication network 10 comprises a plurality of mobile terminals 12, a plurality of base stations 14, and one or more mobile switching centers (MSC) 16. The mobile terminal 12, which may be mounted in a vehicle or used as a portable hand-held unit, typically contains a transceiver, antenna, and control circuitry. The mobile terminal 12 communicates over a radio frequency channel with a serving base station 14 and may be handed-off to a number of different base stations 14 during a call. As will be described later in more detail, mobile terminal 12 is also capable of communicating packet data over the packet-switched network 20.

Each base station 14 is located in, and provides service to a geographic region referred to as a cell. In general, there is one base station 14 for each cell within a given mobile communications network 10. The base station 14 comprises several transmitters and receivers and can simultaneously handle many different calls. The base station 14 connects via a telephone line or microwave link to the MSC 16. The MSC 16 coordinates the activities of the base stations 12 within network 10, and connects mobile communications network 10 to public networks, such as the Public Switched Telephone Network (PSTN). The MSC 16 routes calls to and from the mobile terminals 12 through the appropriate base station 14 and coordinates handoffs as the mobile terminal 12 moves between cells within mobile communications network 10. Information concerning the location and activity status of subscribing mobile terminals 12 is stored in a Home Location Register (HLR) 18. The MSC 16 also contains a Visitor Location Register (VLR) containing information about mobile terminals 12 roaming outside of their home territory.

The illustrative packet-switched network 20 of FIG. 1 comprises at least one Serving GPRS Support Node (SGSN) 22, one or more Gateway GPRS Support Nodes (GGSN) 24, a GPRS Home Location Register (GPRS-HLR) 26, and a Short Message Service Gateway MSC (SMS-GMSC) 28. The packet-switched network 20 also includes a base station 14, which in FIG. 1, is the same base station 14 used by the mobile communications network 10.

The SGSN 22, which is at the same hierarchical level as the MSC 16, contains the functionality required to support GPRS. SGSN 22 provides network access control for packet-switched network 20. The SGSN 22 connects to the base station 14, typically by a Frame Relay Connection. In the packet-switched network 20, there may be more than one SGSN 22.

The GGSN 24 provides interworking with external packet-switched networks, referred to as packet data networks (PDNs) 30, and is typically connected to the SGSN 22 via a backbone network using X.25 or TCP/IP protocol. The GGSN 24 may also connect the packet-switched network 20 to other public land mobile networks (PLMNs). The GGSN 24 is the node that is accessed by the external packet data network 30 to deliver packets to a mobile terminal 12 addressed by a data packet. Data packets originating at the mobile terminal 12 addressing nodes in the external PDN 30 also pass through the GGSN 24. Thus, the GGSN 24 serves as the gateway between users of the packet-switched network 20 and the external PDN 30, which may, for example, be the Internet or other global network. The SGSN 22 and GGSN 24 functions can reside in separate nodes of the packet-switched network 20 or may be in the same node.

The GPRS-HLR 26 performs functions analogous to HLR 18 in the mobile communications network 10. GPRS-HLR 26 stores subscriber information and the current location of the subscriber. The SMS-GMSC 28 contains the functionality required to support SMS over GPRS radio channels, and provides access to the Point-to-Point (PTP) messaging services.

A mobile terminal 12 that has packet data functionality must register with the SGSN 22 to receive packet data services. Registration is the process by which the mobile terminal ID is associated with the user's address(es) in the packet-switched network 20 and with the user's access point(s) to the external PDN 30. After registration, the mobile terminal 12 camps on a Packet Common Control Channel (PCCCH). Likewise, if the mobile terminal 12 is also capable of voice services, it may register with the MSC 16 to receive voice services and SMS services on the circuit-switched network 10 after registration with the SGSN 22. Registration with the MSC 16 may be accomplished using a tunneling protocol between the SGSN 22 and MSC 16 to perform an International Mobile Identity Subscriber (IMSI) attach procedure. The IMSI attach procedure creates an association between the SGSN 22 and MSC 16 to provide for interactions between the SGSN 22 and MSC 16. The association is used to coordinate activities for mobile terminals 12 that are attached to both the packet data network 20 and the mobile communications network 10.

As previously stated, PTT services are typically associated with private radio systems, however, future protocol support for a PTT service over GSM systems is planned. Conventional mobile terminals equipped for a PTT service typically require the user to push and hold a button while speaking. This makes it difficult for users to drive a car, for example, and communicate with a remote party using PTT.

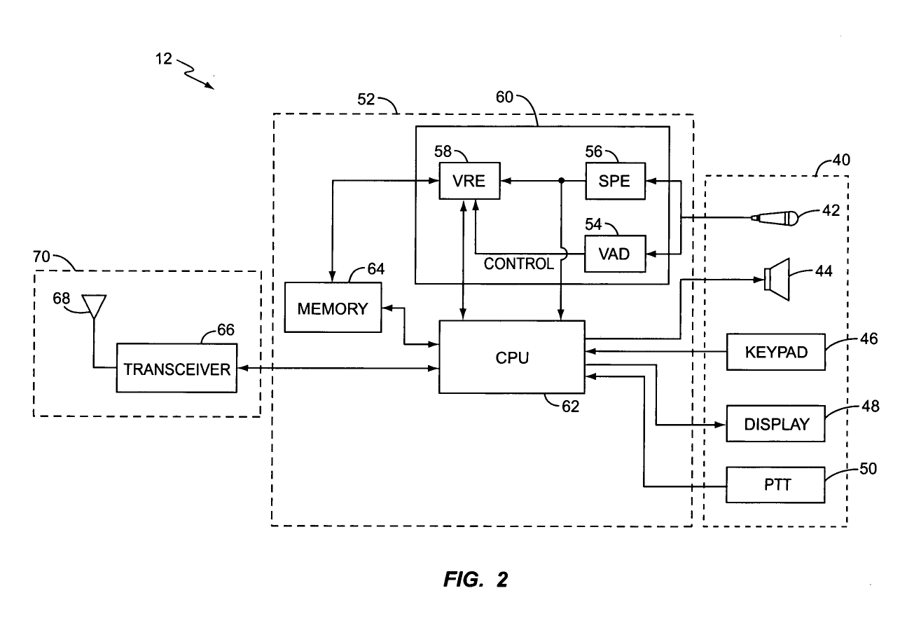

FIG. 2 illustrates one example of terminal 12 according to one embodiment of the present invention. Terminal 12 comprises a user interface 40, circuitry 52, and a transceiver section 70. User interface section 40 includes microphone 42, speaker 44, keypad 46, display 48, and a PTT button 50.

Microphone 42 converts the user's speech into electrical audio signals, and passes the signals to a voice activity detector (VAD) 54 and a speech encoder (SPE) 56 of a speech processor 60. Speaker 44 converts electrical signals into audible signals that can be heard by the user. Conversion of speech into electrical signals, and of electrical signals into audio for the user may be accomplished by any audio processing circuit known in the art. Keypad 46, which may be disposed on a front face of terminal 12, includes an alphanumeric keypad and, other controls such as a joystick, button controls, or dials. Keypad 46 permits the user to dial telephone numbers, enter commands, and select menu options. Display 48 allows the operator to see the dialed digits, images, called status, menu options, and other service information. In some embodiments of the present invention, display 48 comprises a touch-sensitive screen that displays graphic images, and accepts user input.

A user depresses PTT button 50 when the user wishes to speak with a remote party in PTT mode (i.e., simplex mode). While the PTT button is depressed, the user cannot hear the remote party. When PTT button 64 is not depressed, the user may hear audio from the remote party through speaker 44.

Transceiver section 70 comprises a transceiver 66 coupled to an antenna 68. Transceiver 66 is a fully functional cellular radio transceiver that may transmit and receive signals to and from base station 14 in a duplex mode or a simplex mode. Transceiver 66 may transmit and receive both voice and packet data, and thus, operates with both mobile communications network 10 and packet-switched network 20. Transceiver 66 may operate according to any known standard, including the standards known generally as the Global System for Mobile Communications (GSM).

Circuitry 52 comprises a speech processor 60, memory 64, and a microprocessor 62. Memory 64 represents the entire hierarchy of memory in a mobile communication device, and may include both random access memory (RAM) and read-only memory (ROM). Executable program instructions and data required for operation of terminal 12 are stored in non-volatile memory, such as EPROM, EEPROM, and/or flash memory, which may be implemented as, for example, discrete or stacked devices. As will be described below in more detail, memory 64 may store predetermined keywords or voice commands recognized by speech processor 60.

Microprocessor 62 controls the operation of terminal 12 according to program instructions stored in memory 64. The control functions may be implemented in a single microprocessor, or in multiple microprocessors. Suitable microprocessors may include, for example, both general purpose and special purpose microprocessors and digital signal processors. As those skilled in the art will readily appreciate, memory 64 and microprocessor 62 may be incorporated into a specially designed application-specific integrated circuit (ASIC).

Speech processor 60 interfaces with microprocessor 62 and detects and recognizes speech input by a user via microphone 42. Generally, any speech processor known in the art may be used with the present invention, for example, a digital signal processor (DSP). Speech processor 60 may include a voice activity detector (VAD) 54, a speech encoder (SPE) 56, and a voice recognition engine (VRE) 58. VAD 54 is a circuit that performs voice activation detection, and outputs a signal to VRE 58 representative of voice activity on microphone 42. Thus, VAD 54 is capable of outputting a signal that is indicative of either voice activity or voice inactivity. Voice activity detection is well known in the art, and thus, VAD 54 may comprise or implement any suitable VAD circuit, algorithm, or program.

SPE 56 is a speech encoder that also receives an input signal from microphone 42 when voice is present. Alternately, SPE 56 may also receive as input a signal output from VAD 54. The signal from VAD 54 may, for example, enable/disable SPE 56 in accordance with the voice activity/inactivity indication output by VAD 54. SPE 56 encodes the incoming speech signals from microphone 42, and outputs encoded speech to the VRE 58. The encoded speech may be output directly to VRE 58, or via microprocessor 62 to VRE 58. Speech may be encoded according to any speech encoding standard known in the art, for example, ITU G.711 or ITU G.72x.

VRE 58 compares the encoded speech to a plurality of predetermined voice commands stored in memory 64. VRE 58 may recognize a limited vocabulary, or may be more sophisticated as desired. If the encoded speech received by VRE 58 matches one of the predetermined voice commands, VRE 58 outputs a signal to microprocessor 62 indicating the type of command matched. Conversely, if no match occurs, VRE 58 outputs a signal to microprocessor 62 indicating a no-match condition, or simply sends no signal at all.

In one embodiment, the predetermined voice commands are stored as vectors in memory 62, although any known method of representing voice may be used. The manufacturer may load vectors representative of the predetermined voice commands into memory 62. These commands are known as speaker independent commands. Alternatively, a user may customize the predetermined voice commands to be recognized by “training” speech processor 60. These are known as speaker-dependent commands. Typically, the “training” process for speaker-dependent commands involves the user speaking a term or terms into microphone 42. Speech processor 60 then converts the speech signals into a series of vectors known as a speech reference, and saves the vectors in memory 64. The user may then assign the saved voice command to a specific functionality provided by terminal 12. The next time the user speaks the command into microphone 42, VRE 58 compares the spoken command to the vectors stored in memory. If there is a match, the functionality assigned to the voice command executes. For example, a user may train speech processor 60 to recognize the voice commands “BEGIN TRANSMISSION” and “END TRANSMISSION.” These commands would key transmitter 66 to allow the user to begin transmitting speech signals, and unkey transmitter 66 to allow the user to stop transmitting speech signals, respectively. Speaking these commands into microphone 42 would have the same effect as when the user manually depresses (to activate) and releases (to deactivate) PTT button 50. As those skilled in the art will understand, these commands are illustrative only, and other terms may be used as voice commands.

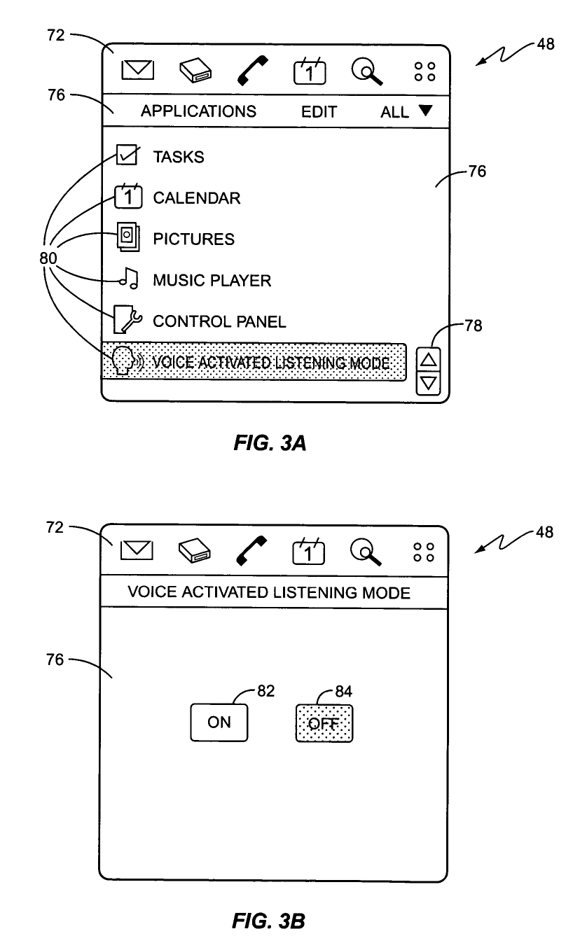

Typically, voice recognition systems will continuously monitor microphone 42 to determine if the user has issued a predetermined voice command. However, since much of the sound energy present at the microphone 42 may not be intended as a voice command, continuous monitoring by the speech processor 60 may tend to decrease battery life. To mitigate this, the present invention also contemplates manually placing speech processor 60 in a “listening” mode via a menu system on terminal 12. That is, the speech processor 60 will only monitor for speech signals present at microphone 42 when placed in this mode. FIGS. 3A and 3B illustrate one such a possible menu system displayed to the user on display 48. In this embodiment, display 48 is a touch sensitive display. However, conventional menu systems requiring user navigation via keypad 46 are also possible.

In FIG. 3A, display 48 displays a main screen comprising a shortcut section 72, a dropdown section 76, a display portion 76, a scroll bar 78, and one or more menu selections 80. The icons in shortcut section 72 launch pre-programmed functionality associated with the icon selected by the user, while dropdown section 76 permits a user to further interact with programs stored in memory 64. Because display portion 76 is limited in size, scroll bar 78 permits the user to scroll up and down to view any menu selections 80 that may not fit on display portion 76. To place speech processor 60 in the listening mode, the user may simply select the associated menu choice. In FIG. 3A, the user selects “VOICE ACTIVATED LISTENING MODE.” This launches a second menu screen illustrated in FIG. 3B. In FIG. 3B, display portion 76 now shows two buttons. Pressing button 82 activates the listening mode, while pressing button 84 deactivates the listening mode. Other controls, such as check boxes and radio buttons, are also possible as desired. Thus, the user may activate the voice recognition functionality of speech processor 60 only when needed, for example, when driving a car, but otherwise retain the ability to manually depress/release PTT button 50.

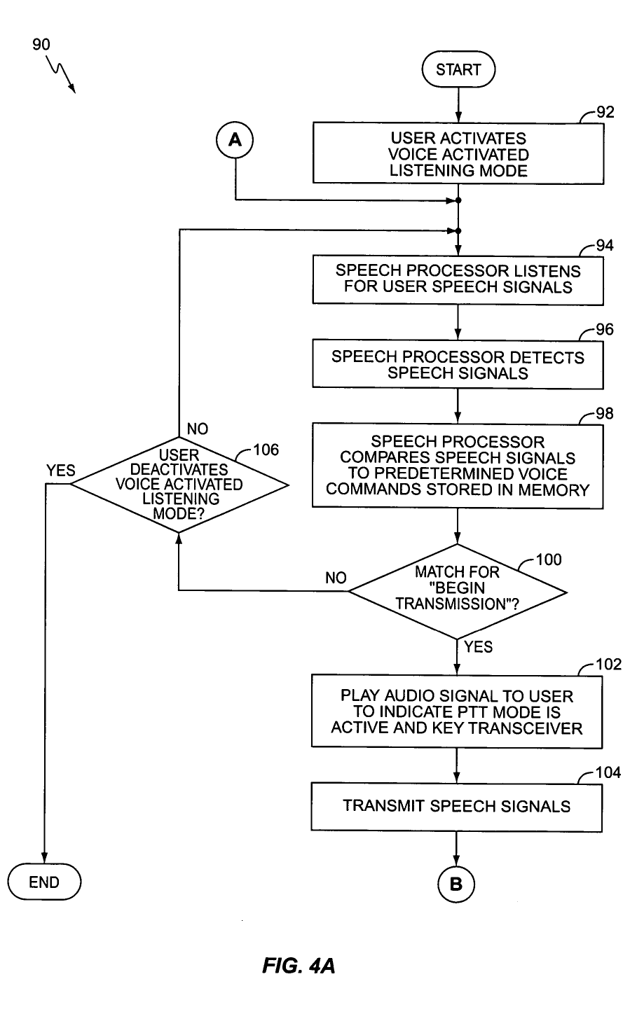

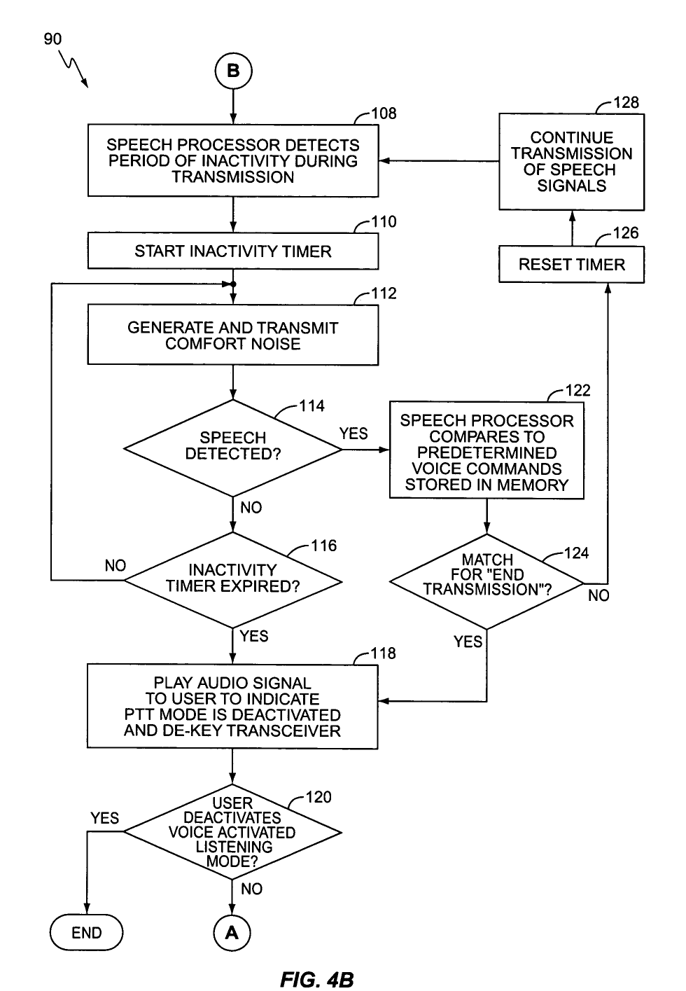

FIGS. 4A and 4B illustrate a possible method 90 of communicating speech signals in PTT mode using terminal 12 of the present invention. In FIG. 4A, method 90 begins when the user activates the listening mode (box 92). In this mode, speech processor 60 listens for speech signals (box 94), and detects speech signals when the user speaks (box 96). The speech processor then compares the speech signals to predetermined voice commands stored in memory 64 (box 98), and determines if there is a match for the command “BEGIN TRANSMISSION” (box 100). If there is a match, microprocessor 62 may cause an audio signal, for example a “beep,” to be rendered through speaker 44 to alert the user that PTT mode is active, and transceiver 66 is keyed (box 102). The user is then free to speak into microphone 42. The speech signals are transmitted to the networks (box 104). In packet-switched networks, these speech signals are converted into data packets, and transmitted to the remote party. Of course, if no match occurs (box 100), a check may be made to determine if the user has deactivated the listening mode (box 106). If the listening mode is still active, speech processor 60 continues to monitor for speech signals present at microphone 42 (box 94), otherwise, terminal 12 returns to normal operation. It should be noted that while FIGS. 4A and 4B check for activation/deactivation of the listening mode at specific points, these checks may be made at any time.

As seen in FIG. 4B, speech processor 60 continues to monitor for speech signals to determine when the user wishes to cease transmitting. Typically, users will pause shortly after finishing a sentence before issuing an “END TRANSMISSION” command to take the terminal 12 out of PTT mode. As stated above, speech processor 60 detects these periods of speech inactivity (box 108), and starts an inactivity timer (box 110). The inactivity timer provides a window that allows for natural pauses in the user's speech, and protects against premature termination of the PTT mode. During these pauses, terminal 12 may generate and transmit comfort noise (box 112) to the remote party as is known in the art, while speech processor 60 continues to monitor for speech signals present at microphone 42 (box 114). If no speech signals are detected, a check is made to determine whether the inactivity timer has expired (box 116). If the timer has not expired, comfort noise continues to be generated and transmitted during the pause (box 112). If the timer has expired, an audio signal (e.g., two beeps in rapid succession) may be rendered through speaker 44 (box 118), and the transceiver 66 is de-keyed. This audio signal indicates to the user that the PTT mode has been terminated. A check is then made to determine if the user has deactivated the listening mode (box 120). If not, control returns to FIG. 4A to await a subsequent voice command or deactivation of the listening mode.

It should be noted that the user may also resume transmission of the speech signals during periods of voice inactivity by speaking into the microphone before the timer expires, or by issuing a predetermined voice command, such as “RESUME TRANSMISSION.” Speech processor 60 would process these speech signals and/or commands, and transceiver 66 would simply resume transmitting speech signals.

If, however, speech processor 60 detects speech signals before expiration of the timer (box 114), speech processor 60 compares them to the predetermined voice commands stored in memory 64 (box 122). If there is a match for the voice command “END TRANSMISSION” (box 124), the audio signal indicating termination of transmission is played through the speaker for the user, and transceiver 66 is de-keyed (box 118). The user may now hear the transmissions of the remote party through speaker 44. Otherwise, the inactivity timer is reset (box 126), and transmission of the speech signals to the remote party continues (box 128). If speech processor 60 detects a period of inactivity (box 108), the inactivity timer is started once again (box 110).

It should be noted that the present invention may buffer the user's speech signals in memory, or alternatively delay transmission of the speech signals. This would permit speech processor 60 or microprocessor 62 to “filter” out the command spoken by the user. As a result, the remote party would only receive the user's communications, and not hear the user's spoken commands.

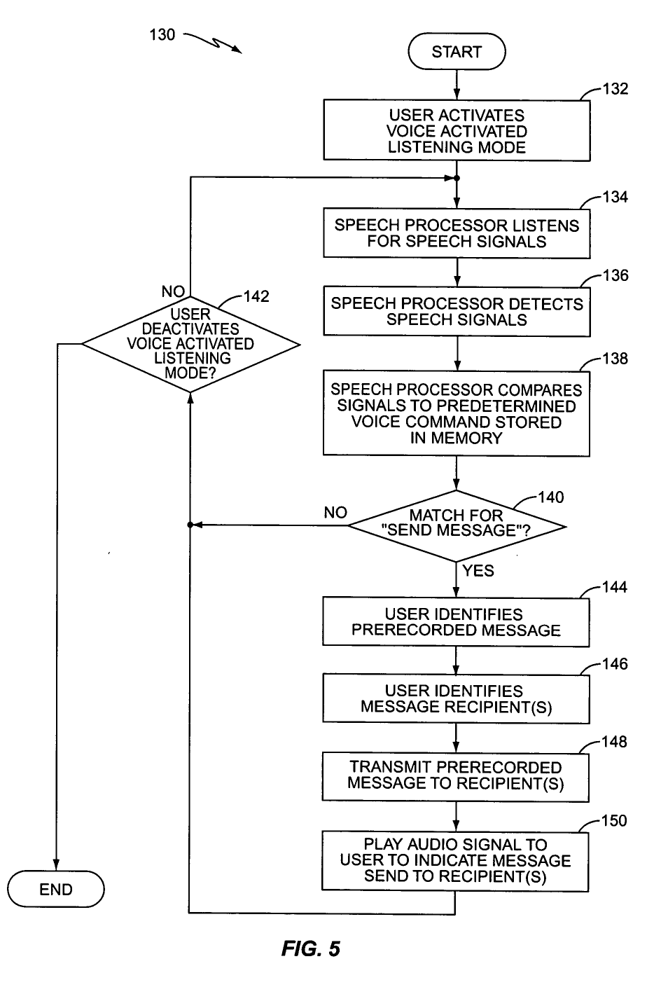

In addition to transmitting speech signals in a PTT mode, an alternate embodiment of the present invention contemplates transmitting the speech signals to one or more recipients simply by issuing a voice command. For example, the user might prerecord a message for delivery to the members of an affinity group. In FIG. 5, a method 130 illustrates one such embodiment.

As seen in FIG. 5, the user activates the voice-activated listening mode (box 132). In this mode, speech processor 60 listens for and detects speech signals input by the user (box 134, 136). The speech processor 60 then compares the speech signals to the predetermined voice commands stored in memory 64 (box 138). If there is a match for the command “SEND MESSAGE” (box 140), the user then identifies a prerecorded message for transmission (box 144), and one or more intended recipients (box 146). Of course, if no match occurs (box 140), a check may be made to determine if the user has deactivated the listening mode (box 142). If the listening mode is still active, speech processor 60 listens again for speech signals present at microphone 42 (box 134), otherwise, terminal 12 returns to normal operation.

Recipients may be identified singularly by name, for example, or by an associated group identifier. In the latter case, the recipients may be part of an affinity group already associated with an affinity group identifier in the wireless communications device. Affinity groups are well known, and thus, are not discussed in detail here. The prerecorded message is transmitted to the identified recipients (box 148), and an audio signal rendered through speaker 44 indicates that the message has been sent (box 150). Once the message is sent, speech processor again checks to see if the voice activated listening mode has been deactivated (box 142), and continues operation accordingly. Of course, while not explicitly shown in FIG. 5A, the user may end sending a message at any time by saying, for example, “STOP MESSAGE.”

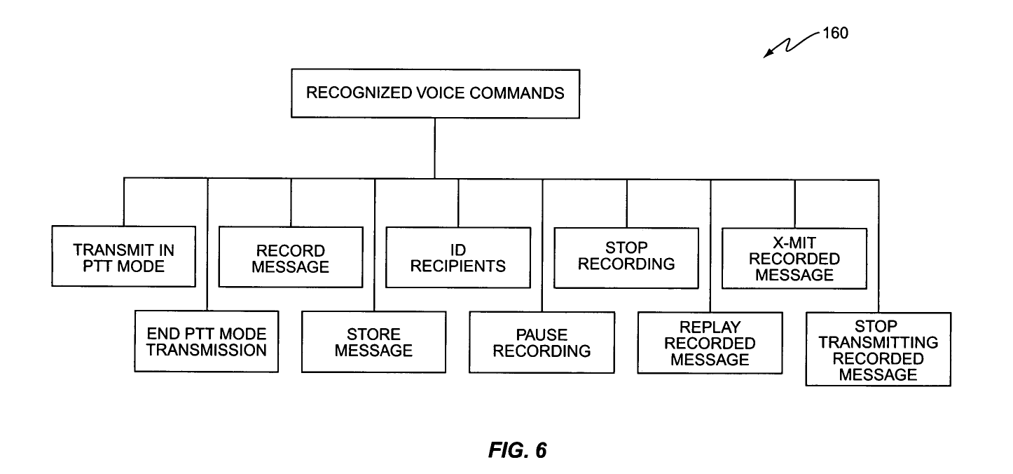

Those skilled in the art will understand that the voice commands as detailed above are merely illustrative, and in no way limiting. Any term or terms may be used as a voice command, and associated with a function of terminal 12. FIG. 6 illustrates some possible functions 160 that may be controlled using the present invention.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A wireless communication device comprising:
a transceiver operative to communicate in a push-to-talk mode;
a speech processor including a voice recognition engine to process speech signals and to recognize predetermined voice commands; and
said transceiver operative to transmit said speech signals in said push-to-talk mode responsive to the detection of said predetermined voice commands.

2. The wireless communication device of claim 1 wherein said transceiver is further operative to end transmission of said speech signals responsive to the detection of said predetermined voice commands.

3. The wireless communication device of claim 1 wherein said transceiver is further operative to stop transmission of said speech signals responsive to the expiration of a timer.

4. The wireless communication device of claim 1 further comprising a controller to control said transceiver.

5. The wireless communication device of claim 4 wherein said controller activates and deactivates said push-to-talk mode responsive to the detection of said predetermined voice commands.

6. The wireless communication device of claim 4 wherein said controller activates and deactivates a listening mode for said speech processor responsive to menu commands input by a user.

7. The wireless communication device of claim 1 wherein said speech processor further includes a voice activity detector connected to said voice recognition engine to detect said speech signals.

8. The wireless communication device of claim 7 wherein said voice activity detector further detects periods of speech inactivity.

9. The wireless communication device of claim 8 wherein said transmitter transmits comfort noise responsive to said detected periods of speech inactivity.

10. The wireless communications device of claim 8 wherein said transceiver is further operative to resume transmission of said speech signals before the expiration of a speech inactivity timer.

11. The wireless communications device of claim 7 wherein said transceiver is further operative to resume transmission of said speech signals responsive to the detection of said predetermined voice commands.

12. The wireless communication device of claim 7 wherein said speech processor further includes a speech encoder to encode said speech signals.

13. The wireless communication device of claim 12 further comprising memory to store representations of said predetermined voice commands, and wherein said voice recognition engine compares said speech signals to said representations of said predetermined voice commands.

14. A method of communicating speech signals as packet data from a wireless communications device comprising:
detecting speech signals spoken by a user of the wireless communications device;
recognizing predetermined voice commands spoken by the user of the wireless communications device; and
transmitting said speech signals in a push-to-talk mode responsive to the detection of said predetermined voice commands.

15. The method of claim 14 further comprising ending transmission of said speech signals responsive to the detection of said predetermined voice commands.

16. The method of claim 14 further comprising activating said push-to-talk mode responsive to the detection of said predetermined voice commands.

17. The method of claim 14 further comprising deactivating said push-to-talk mode responsive to the detection of said predetermined voice commands.

18. The method of claim 14 further comprising deactivating said push-to-talk mode responsive to the expiration of a timer.

19. The method of claim 14 further comprising causing transmission of said speech signals responsive to periods of detected voice inactivity.

20. The method of claim 19 further comprising resuming transmission of said speech signals responsive to the detection of said predetermined voice commands.

21. The method of claim 14 further comprising activating and deactivating a listening mode responsive to one or more menu commands input by the user.

22. A wireless communications system comprising:
a base station; and
a wireless communications device comprising:
a transceiver operative to communicate in a push-to-talk mode;
a speech processor including a voice recognition engine to process speech signals and to recognize predetermined voice commands input by a user; and
said transceiver operative to transmit said speech signals in said push-to-talk mode responsive to the detection of said predetermined voice commands.

23. The wireless communications system of claim 22 wherein the wireless communications system comprises a packet-switched network.

24. The wireless communications system of claim 22 wherein the speech signals are transmitted as data packets.

25. A wireless communication device comprising:
a transceiver to communicate over a wireless communications network;
a speech processor including a voice recognition engine to process speech signals and recognize predetermined voice commands;
a controller operatively connected to said transceiver and said speech processor to control said transceiver to transmit said speech signals responsive to the detection of said predetermined voice commands.

26. The wireless communications device of claim 25 wherein said speech signals comprise a prerecorded message.

27. The wireless communications device of claim 26 further comprising memory to store said prerecorded message.

28. The wireless communications device of claim 26 wherein said controller further controls said speech processor to activate a recording session responsive to the detection of said predetermined voice commands.

29. The wireless communications device of claim 28 wherein said controller further controls said speech processor to deactivate said recording session responsive to the detection of said predetermined voice commands.

30. The wireless communications device of claim 28 wherein said controller further controls said speech processor to pause said recording session responsive to the detection of said predetermined voice commands.

31. The wireless communications device of claim 28 wherein said controller further controls said speech processor to replay said prerecorded message responsive to the detection of said predetermined voice commands.

32. The wireless communications device of claim 26 wherein said predetermined voice commands identify a recipient of said prerecorded message.

33. The wireless communications device of claim 32 wherein said recipient comprises an affinity group having one or more members.

34. The wireless communications device of claim 32 wherein said controller controls said transceiver to transmit said prerecorded message to said identified recipient.

35. The wireless communications device of claim 34 wherein said controller further controls said transceiver to end transmission of said prerecorded message to said identified recipient.

36. A method of communicating speech signals over a wireless communications device comprising:
detecting speech signals uttered by a user of the wireless communications device;
recognizing predetermined voice commands issued by the user of the wireless communications device; and
transmitting said speech signals responsive to the detection of said predetermined voice commands.

37. The method of claim 36 further comprising recording said speech signals to create a prerecorded message responsive to the detection of said predetermined voice commands.

38. The method of claim 37 further comprising saving said prerecorded message in memory responsive to the detection of said predetermined voice commands.

39. The method of claim 37 further comprising pausing said recording responsive to the detection of said predetermined voice commands.

40. The method of claim 37 further comprising replaying said prerecorded message responsive to the detection of said predetermined voice commands.

41. The method of claim 37 further comprising identifying a recipient of said prerecorded message.

42. The method of claim 41 wherein said recipient comprises an affinity group having one or more members.

43. The method of claim 36 wherein transmitting said speech signals comprises transmitting said speech signals as packet data responsive to the detection of said predetermined voice commands.
